(19) United States
(12) Patent Application Publication
(10) Pub. No.: US 2026/0289546 A1
(43) Pub. Date: Sep. 24, 2026

(54) CONTACTLESS PAYMENT ON A DISTRIBUTED LEDGER USING NFC

(71) Applicant: AVA LABS, INC., New York, NY (US)

(72) Inventor: Furkan BOYRAZ, Istanbul (TR)

(21) Appl. No.: 19/475,400

(22) PCT Filed: Apr. 17, 2024
(86) PCT No.: PCT/IB2024/053750

§ 371 Date: Oct. 14, 2025

Related U.S. Application Data
(60) Provisional application No. 63/496,632, filed on Apr. 17, 2023.

(51) Int. Cl. G06Q 20/32; G06Q 20/20; G06Q 20/38; G06Q 20/40

(52) U.S. Cl. CPC G06Q 20/3278; G06Q 20/209; G06Q 20/3821; G06Q 20/40; G06Q 2220/00

(57) ABSTRACT

A method and system for contactless payment on a distributed ledger using near field communications (NFC). A point of sale device is placed in the NFC host card emulation (HCE) mode. A customer device uses its NFC system to read transaction details from the POS device. The customer device generates a digitally signed transaction message and sends it to the distributed ledger to initiate a transfer of cryptocurrency funds from the customer's account the merchant's account. The merchant system monitors the distributed ledger to determine when the transaction is complete. The merchant device can start in the NFC read state and switch to NFC HCE mode in response to data read from the customer device.

### CROSS-REFERENCE TO RELATED APPLICATIONS:

This application claims priority to U.S. Provisional Patent Application No. 63/496,632, filed on Apr. 17, 2023, the entire contents of which expressly incorporated by reference.

### BACKGROUND:

Near Field Communication (“NFC”) is a short range wireless communication protocol designed to operate over a small distance, such as around 4 cm, and allows for the transfer of data from a passive NFC tag or chip to an active NFC device. NFC technology is widely used for contactless payment systems. In such systems, the merchant has an NFC enabled point of sale (POS) device that operates in a read mode of operation to detect and read data from NFC tags brought within the read distance. Customers can make payment using a bank card with an embedded NFC chip that has the customer debit or charge account information. When their card is brought within the read range of the POS device, the POS device reads the customer payment information and can use that to process the transaction.

Conventional smart phones also support NFC and use this technology to allow for mobile payments. To use a smart phone as a payment device, its NFC system is placed in a host card emulation (HCE) broadcast mode of operation which emulates a passive NFC chip. When the phone is brought near the POS device, it appears to the POS device as a payment card and the POS device reads the payment data from the phone. Smart wallet software, such as Apple Pay and Google Pay, can be used to store a multiple credit and debit card information and a user can select a payment card to use for a given transaction.

FIG. 1 is an illustration of a conventional system 100 and process for contactless payment using an NFC chip payment card 10 or NFC enabled smart device 15 with a merchant POS device 20. The process of a contactless payment begins when the customer holds their card 10 or mobile device 15 with an embedded NFC chip near the POS device 15 allowing payment information to be read by the POS device 15 (step 101). The POS device 15 emits a radio frequency that powers the chip in the card or device, allowing it to transmit its unique encrypted code. For a credit card device 10, the embedded NFC chip will transmit encrypted information identifying the cardholder's account. For a smart device 15, internal wallet or other transaction application software in the smartphone is used to maintain customer payment information, such as for a virtual credit card account. When the payment feature is active, the software switches the phone NFC system to HCE mode. The customer holds the smartphone 15 near the POS device 20. The POS device 20 which emits a radio frequency that powers or is detected by the NFC chip in the smartphone. The application software configures the NFC system so that in response to the read from the POS device the selected user card account number is transmitted from the phone 20.

The payment account information is authenticated by the POS device 20 using a unique encrypted code. When the code is verified, the POS device 20 sends the card number and transaction amount, along with other required information, to the designed card processing network 25 (such as Visa or Mastercard) (step 102). The card processing network 25 then passes the transaction information to the card issuer 30 for authorization (step 103). Once the card issuer 30 verifies the payment, the card issuer 30 transfers the funds from the customer's account to the merchant's account (not shown) and a transaction approval message is sent through the card network back to the POS device 30 (step 104).

This process using either a card or smart device typically takes between 5 to 15 seconds to complete and the same security measures for the POS transaction processing apply regardless of whether the account information is received by the POS device over the NFC link from a card or a card emulator in a smart device. When a smart device is used, the security of HCE payments also depends on the security of the smartphone, the security of the mobile wallet app and the security of the NFC communication between the phone and the POS.

While very successful, the present NFC payment methodology suffers from various deficiencies. Not all smart devices that include NFC systems support the HCE mode of operation in a manner that would allow the use of the device in an NFC digital transaction as discussed above. Other devices limit the use of HCE mode. For example, HCE mode on iOS devices is currently only supported for use by Apple Pay.

In addition, most POS devices are computationally weak devices since they are designed for limited functions and. A typical POS device has a processor operating at 1 GHz or slower and up to 2 GB of RAM. Conventional payment scenarios using credit card or smartphone acting as a credit card (HCE mode) requires the POS terminal to carry the sender's account information to the processor. To integrate a blockchain functionality into conventional systems a POS device would be required to be at least a light-node in a blockchain based payment scenario. This would require more computational resources than available at a typical POS device. Operation as a blockchain node may also require more energy than typically supplied to a POS device.

### SUMMARY

These and other deficiencies are met by a method and system as disclosed herein which provides contactless payment utilizing near field communication (NFC) technology in a manner that supports cryptocurrency transactions and recording of transactions on a distributed ledger, such as blockchain.

The customer device, such as a smart phone, and a merchant POS device each support the NFC communication protocol. The merchant and customer also each have a currency account on distributed ledger and a public and private key associated with their account.

In a transaction, the merchant inputs the transaction amount to the POS device. Opposite from conventional NFC transaction methods, the POS device is placed into the HCE broadcast mode of option and the customer device operates in the NFC read mode of operation to read the transaction information from the POS device. The transaction information can comprise a transaction amount and the merchant public key for the cryptocurrency account to which payment should be made. Information about the transaction, such as the price and currency, can be shown on the customer device and the customer asked to approve the transaction. The customer device can also use the received merchant public key to retrieve information about the merchant from the distributed ledger and merchant information also displayed to the user as part of the transaction approval process for the user.

Software in the user device generates a transaction message comprising the transaction amount and the merchant public key. The transaction message is signed with the customer private key and then sent by the customer device to the distributed ledger to initiate a transfer of funds from the customer account to the merchant account associated with the merchant public key. The POS device can also provide a transaction ID, such as a random nonce number, as part of the transaction information and this transaction ID can be included in the transaction message.

On receipt of the transaction request, the transaction is processed using convention al methods as appropriate for the digital currency and distributed ledger at issue. In general, the ledger system will verify that that the user's account has sufficient funds available and then record the transfer in the ledger.

The POS device can monitor the ledger records for the transfer of the funds. When the POS device detects that the transaction has succeeded and been written to the ledger, an indication that the transaction was successful can be output, such as on a display of the POS device.

The transaction can be in the form a smart contact that is executed automatically. In an embodiment the merchant has a merchant messaging ID, such as a text message number or IM address, and this can further be included in the transaction information provided to the customer device and included in the transaction message. The smart contact can include functionality that will automatically send a message to the Merchant's messaging ID indicating that the transaction was successful (or otherwise indicating that it failed for a specified reason). In this embodiment, the merchant would not need to actively monitor the ledger to determine if the transaction was successful but instead could wait to receive a message associated with the transaction upon operation of the smart contact.

In a particular embodiment, the transaction is initiated as a conventional NFC transaction with the customer device in HCE mode emulating a passive NFC chip. When the customer device is brought near the POS device, the POS device will detect and read the data provided by the customer device. Instead of providing transaction card information, the customer device can instead provide data indicating that an alternative transaction methodology (as disclosed herein) is to be used. When the POS device detects that the alternative transaction methodology is signaled, the POS device enters HCE mode and the transaction process proceeds as disclosed above with the customer device in the read mode of operation.

The present method can be implemented as a software applications installed into memory of the customer and POS devices and executed by the respective device processors. Various additional functions can be added as well. In one embodiment, the customer device and POS device can exchange information about different types of cryptocurrencies that are supported and the user can select the desired cryptocurrency to use for the transaction.

The disclosed system and method provides a novel approach to contactless payments by combining the convenience and security of NFC technology with the transparency and immutability of blockchain technology. It is a significant advancement in the field of digital payments that can greatly benefit businesses and consumers alike.

Advantageously, the method and system as disclosed allows for secure and efficient transactions by allowing a user to make payments using their NFC-enabled device, such as a smartphone, in conjunction with a merchant's point-of-sale terminal. The payment is processed and recorded on a blockchain, providing an immutable record of the transaction. This technology can greatly benefit businesses and consumers alike by increasing the speed and security of transactions while reducing the need for cash or physical cards.

The system and method allows for the easy integration of cryptocurrency as a form of payment, further expanding the range of payment options available to both merchants and consumers. Unique and secure digital identities for users are created for use with the blockchain technology and these identities can be used for various other applications as well, such as loyalty programs and digital wallets that can be used in conjunction with the present payment system.

The system and method can be implemented in a variety of settings, including retail stores, online marketplaces, and peer-to-peer transactions. It can also be easily integrated with existing point-of-sale terminals, making the transition for businesses seamless.

Another benefit of this system and method is its ability to integrate with upcoming Central Bank Digital Currencies (CBDCs). As more and more countries are exploring the use of CBDCs, this technology will enable smooth integration of CBDCs into the existing payment infrastructure. This will help facilitate the wider adoption of CBDCs by providing a secure and efficient way for consumers to make transactions using digital currencies issued by their respective central banks. The use of blockchain technology will ensure the secure recording of all CBDC and crypto transactions, providing an immutable record for any regulatory or auditing purposes. This can help to allay any concerns of central banks and governments regarding the potential risks and challenges associated with the issuance and use of CBDCs and cryptocurrencies.

### DESCRIPTION OF THE DRAWINGS

Further features and advantages of the invention, as well as structure and operation of various implementations of the invention, are disclosed in detail below with references to the accompanying drawings in which:

FIG. 1 is an illustration of a conventional system and process for contactless payment using an NFC;

FIG. 2 is a high level diagram of a system 200 illustrating a high level data flow in an implementation of a new method for contactless payment on a distributed ledger using NFC

FIG. 3 is an example transaction information and approval screen;

FIGS. 4A-4C are high level flowcharts of features of the new methodology; and

FIG. 5 is simplified block diagram of a customer device and POS device.

### DETAILED DESCRIPTION

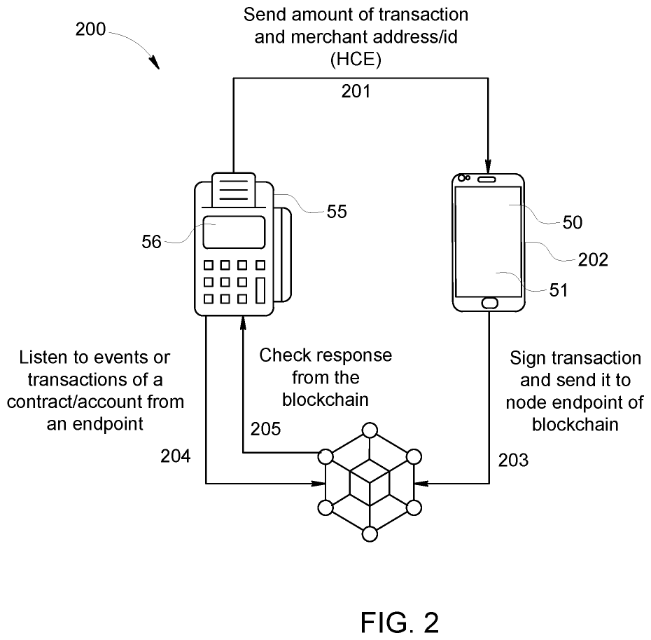

FIG. 2 is a high level diagram of a system 200 illustrating a high level data flow in an implementation of a new method for contactless payment on a distributed ledger using NFC. The system comprises a customer device 50 and a point of sale device 55. The customer device 50 is a smart phone or other computing device, such as a tablet computer, that has NFC capabilities and may be used by a customer in the course of a transaction with a merchant. Customer device 50 comprises one or more internal processors that operate to execute application programs stored in an internal memory including an electronic wallet application implementing the present method. A user interface, such as a touch screen display 51, is used to present information to the user and receive user input. POS device 55 has one or more processors that execute an application program stored in memory for engaging in customer transactions, including NFC capabilities. POS device 55 may also have a display 56, as well as other components, such as a keyboard, card slot, magnetic stripe reader, and receipt printer.

Customer device 50 and POS device 55 are have network communication functionality allowing communication with a distributed ledger system 60, such as a public blockchain, that is accessible through a network, such as the Internet (not shown). The merchant associated with the POS device 55 and the user associated with customer device 50 each can access a cryptocurrency account through a public/private key system. The private key allows an account owner to control their account, e.g., spend funds. A public key is used to provide an address for the account. The public key in the context of the present invention is used in place of an IBAN or Account number used for transactions in conventional payment systems. A customer can use their private key to make a cryptocurrency payment to the merchant account identified by the merchant's public key. Different public keys may be available for use with different cryptocurrencies stored on different blockchains. An e-wallet application on the user device 50 can be use to store the user's public and private keys for their crypto accounts and provide the functionality needed to communicate with the blockchain to engage in transactions.

With reference to FIG. 2, the POS device 55 store the merchant's account number used for cryptocurrency transaction. This can be the public key of the merchant's crypto wallet. Different public keys may be available for use with different cryptocurrencies stored on different blockchains.

In a transaction, a cashier inputs the amount of the transaction to the POS system 55. The POS 55 device puts its NFC circuitry into HCE mode (as opposed to Read Mode used in conventional payment processing). To initiate payment, the customer opens a electronic wallet or other payment app on their smart device 50. A “pay” button on the app can be used to signal the app to turn on the NFC chip in the user's device in Read Mode. When the user's device is in NFC read mode and is brought close enough to the POS device, the NFC system in the user device will detect the POS NFC circuitry operating in HCE mode and initiates a read of data from the NFC in the POS device 55. The POS 55 device responds by transmitting the merchant's account information for the payment currency type and the amount for the transaction (step 200) and this data is captured by the consumer device 50 (step 201). A unique transaction ID, such as a random nonce, can also be generated by the POS system and provided to the user device.

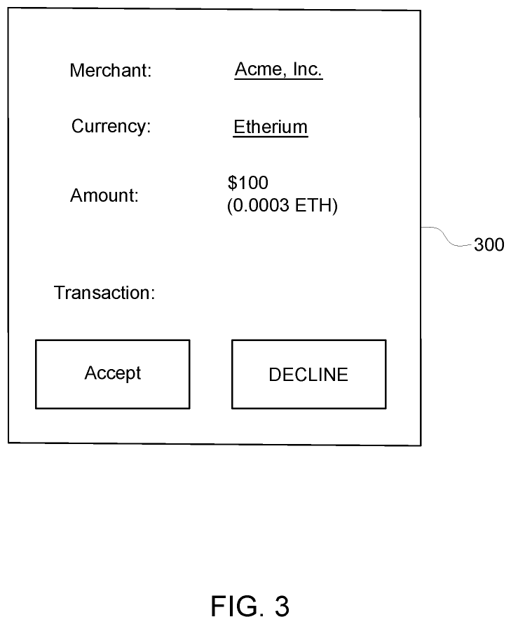

After the user's device 50 captures the address and amount of the transaction, the transaction app can display to the user the amount of the transaction and information about the account to receive the funds and the user can accept or decline the transaction. FIG. 3 is an example of a transaction information and approval screen 300 that can be output on the display 51 of a consumer device 50. The app can also use the merchant's account info to query the blockchain 60 for information about the merchant's account from the blockchain, such as the name of the merchant or other data and this can be displayed as well. As such, the user knows not only how much they will be paying but where the payment will go. This information adds an additional security layer since the user can easily verify the appropriate transaction amount before committing to pay. The user can review the transaction information and if it is correct, they can indicate on the app that they are accepting the transaction to initiate the payment process. If the information is not correct, the user can decline the transaction.

After a transaction is accepted by the user, the app will generate a transaction message, sign the transaction with user's private key, connect to a node endpoint for the blockchain and send a transaction message to the blockchain via an API of the node endpoint. (Step 203). The transaction message can be in various forms, including a smart contract. An appropriate format for the transaction message can depend on the cryptocurrency and/or blockchain at issue and the node endpoint protocol. The transaction message includes the user's private key, the merchant's account number, and the transaction amount. It can also include other information, such as a unique transaction ID generated by the merchant and provided to the user device with other transaction information. Various techniques for sending transaction requests to a blockchain, including through a smart contract will be known to those of ordinary skill in the art.

On receipt of a transaction message, the node of the blockchain 60 will use conventional processes to verify that transaction requirements are met, such as the user having sufficient funds in their cryptocurrency account. If required criteria are satisfied, the transaction gets accepted and the transfer of the currency is written on the blockchain.

During the transaction process the POS system 55 can monitor the events on the blockchain to see if the transaction has been written. The POS system can listen to the blockchain in various ways, such as by using a websocket, and only focusing on contract transactions and events or directly monitoring transactions for specified accounts. (Steps 204, 205) When POS system 55 sees the transaction and confirms the proper currency transfer has occurred, the POS system 55 can output a message on its display 56 indicating that the transaction was successful and take other action, such as print a receipt as usual. If the transaction is unseen at the end of the timeout period,, such as 15 second, 30 seconds, or more, the POS system can mark the transaction as failed and listening stops.

There are various ways that a POS device 55 can check to see if a transaction has been completed. In on embodiment, the POS can look for a transaction written the blockchain with the unique transaction ID that was generated for that transaction and that was sent to the user's device along with other data. Alternatively, the POS system can monitor the cryptocurrency account designed by the merchant to receive payment and merchant's account to look for a transaction adding the expected amount to the merchant's account. This second approach is best suited for applications where the total volume of transactions expected is low and so the risk of two transactions for the same amount being processed at the same time is minimal. In yet a further alternative, the POS device can have an associated messaging ID, such as a text or IM account. This information can also be provided to the user app as part of the transaction data. The transaction request can be in the form of a smart contact that is configured to automatically send a to the designated messaging ID for the merchant the result of the transaction, such as that the transaction was successful or that the transaction failed.

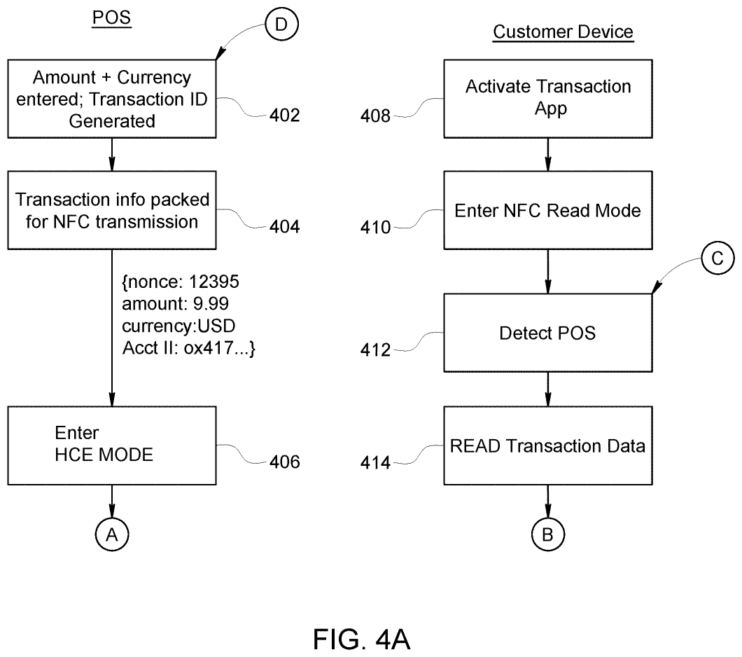

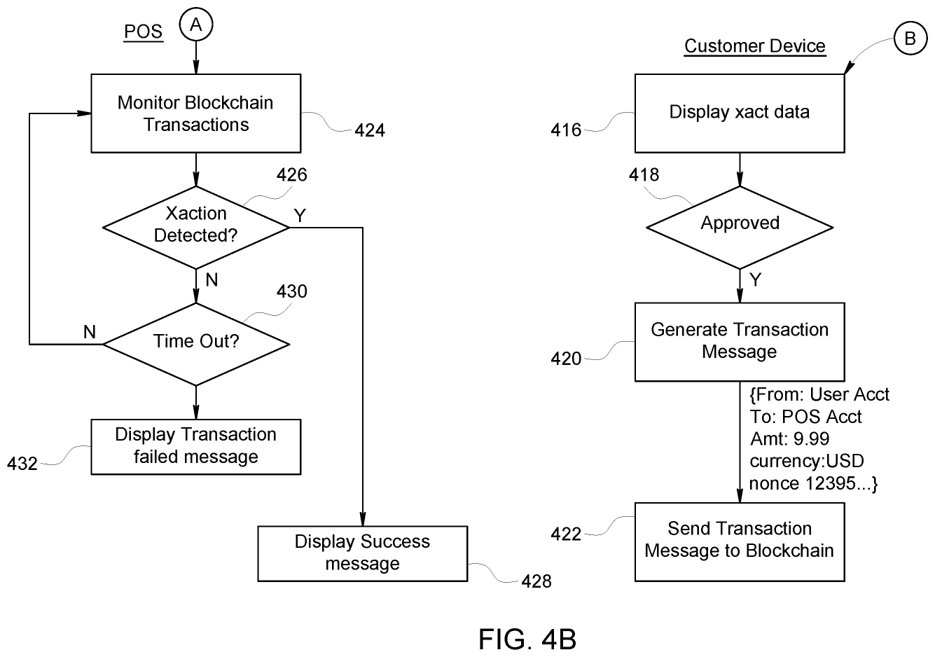

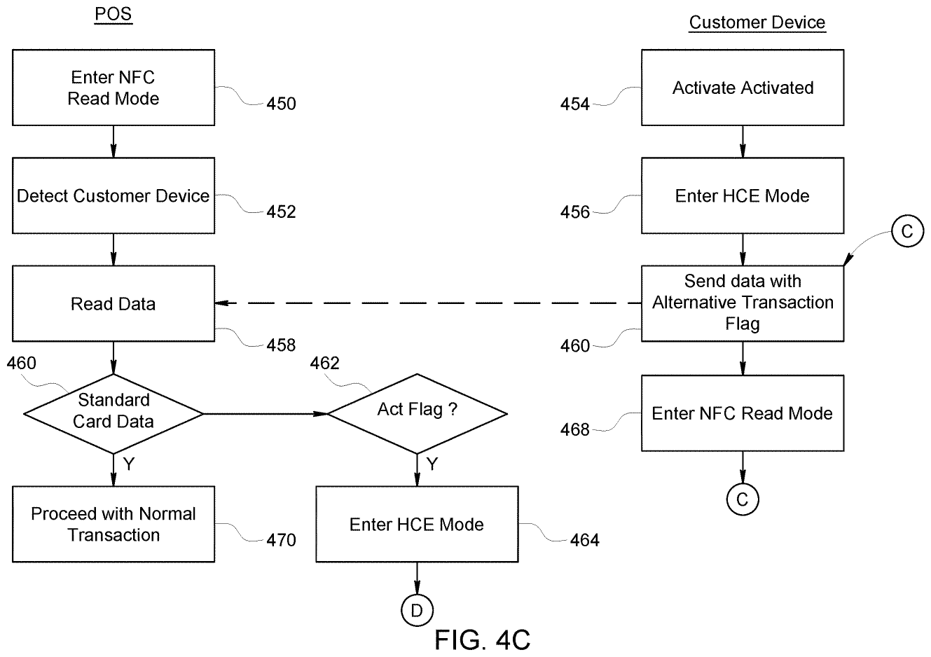

The transaction process is shown in more detail in the flow diagrams of FIGS. 4A and 4B. At the start of the transaction, the purchase price is entered into the POS system 55. The cashier can also have an option to enter a specific currency, such as a crypto currency type. There can be a default currency or there may be several permitted standard and/or cryptocurrencies currencies which are acceptable to the merchant and that can be presented for selection. The currency selection options can be presented on the display 56 on the POS device 55 and the user asked to select one they want to use. A transaction ID is generated. This can be a random nonce number which serves as the serial number for the specific transaction. (Step 402). The transaction software in the POS device 55 then packs the transaction information for NFC transmission, enters the HCE mode to mimic a passive NFC chip, and sets the transaction information to be broadcast (steps 404, 406). In an exemplary implementation, the packed transaction data comprises data specifying a unique transaction ID, the amount of the transaction, the currency, and the merchant's account number, which can the public key of the merchant's cryptocurrency account. Other information can also be provided.

A customer engaging in the transaction opens their payment app, such as an e-wallet. (Step 408). The customer may be given the option to select a payment currency and other transaction options. The payment app may have multiple different customer accounts, some of which may be intended for use with the present methodology, such as a cryptocurrency account, while others, such as a conventional credit or debit card account, use conventional NFC payment protocols. If the transaction is to be done using the present methodology, the app puts the Customer device into the NFC read mode. (Step 410). When the customer device 50 is brought near enough to the POS device 55, the POS device 55 is detected and the customer device 50 reads the transaction data from it. (Steps 412, 414).

Turing to FIG. 4B, using the transaction data from the POS device, the app in the user's phone can display the transaction information and ask the user to indicate whether or not the transaction is approved (steps 416, 418). If approved a transaction message is generated (step 420) and sent to the blockchain node for execution (step 422). The transaction message should specify at least (i) a transfer from the user's crypto account to the merchant's account, (ii) the amount of the transaction, (iii) the currency at issue, and (iv) the transaction nonce code (transaction ID) provided by the POS device.

During this time, the POS device monitors the blockchain for a transaction using the transaction ID and the transaction amount (step 424). The merchant device can start looking for the transaction in the blockchain immediately after the transaction data is read by the user's device or it can wait a period of time before starting to monitor the blockchain transactions. This period of time may be different for different blockchains and currencies based on how long a typical transaction would take to be recorded in the blockchain so it could be discovered by the POS system. Likewise the delay between checks for the transaction can be selected based on which blockchain is used. If the transaction ID found along with the correct amount (step 462), the transaction is deemed a success and a message indicating this can be displayed (Step 428). If the expected transaction is not found, the POS system can check again after a defined period of time, such as 1 or 2 seconds. It the transaction is not detected within a predetermined time out period (step 430), the transaction is deemed to have failed and a transaction failure message can be displayed (step 432). As previously discussed, depending on how the transaction is implemented, such as via a smart contract, instead of monitoring the blockchain, the POS device can instead monitor its designated messaging address.

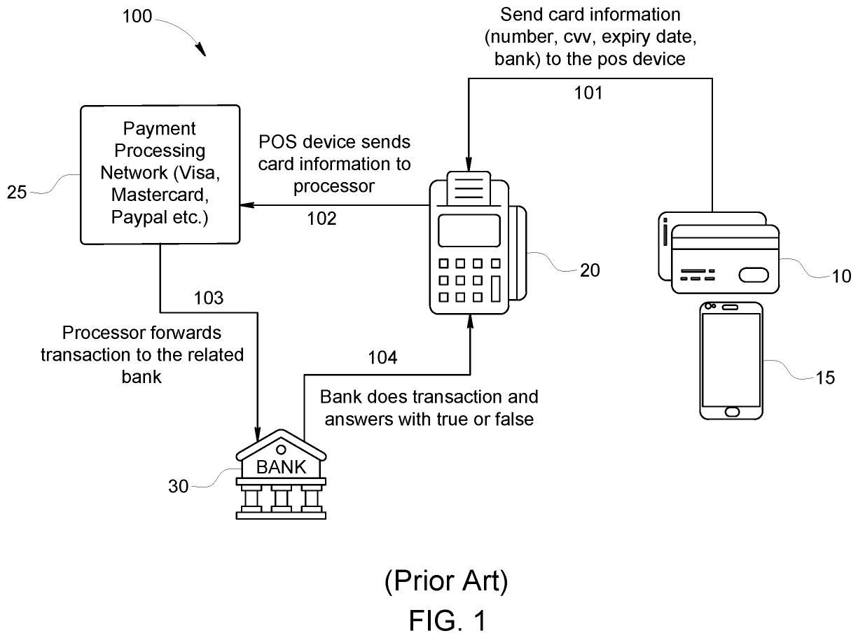

In a variation, and with reference to FIG. 4C, the POS device 50 is operating in a conventional transaction state in which it start in NFC read mode and waits to detect a customer device (Steps 450, 452). A customer engaging in a transaction with their smart device 50 opens payment app (step 454) and their device 50 is set to an initial NFC broadcast state with its NFC chip in HCE mode, as in a conventional transaction. (Step 456). When the user brings their device 50 near the POS device 55, the POS device will read data from the mobile device. (step 458). Instead of card data as would be sent in a conventional NFC transaction, data sent by the app include an indication that the presently disclosed new transaction methodology is to be used instead. (Step 460). The specific signaling data used for this process can vary. In one embodiment, the data record sent can include a flag that signals the type of transaction methodology to use. The POS device can check the received data to determine if it standard card data to be processed conventionally or if the alternative transaction process flag is set (steps 460, 462). If the alternative transaction methodology is to be used, the POS device 55 switches from NFC read mode to the HCE mode (step 464) and the process continues as previously discussed, e.g., at Step 402. Otherwise, the POS device can proceed using conventional processing, such as illustrated in FIG. 1. The app on the customer device 50 switches it form HCE mode to NFC read mode (step 468) and the process continues as previously discussed, such as at Step 412.

While POS device can automatically be switched to the HCE state upon reading data from the customer's device indicating that the present payment methodology is to be used and the customer device 50 may also switch states automatically, in a variation, the app may ask the customer to select the transaction methodology. For example, the customer may be given the option to select an option to advance to this state so that the user can first confirm, such as by a visual or audio output from the POS device, that the POS system supports the present transaction methodology or, if not supported, whether the app should use a conventional e-wallet transaction payment method instead.

In addition to signaling to the POS device 55 to use the present transaction methodology, the customer app can also broadcast to the POS device the currency preferred by the user for the transaction. This data can be indicated in the HCE mode data sent by the customers device (Step 460). If the user has multiple currencies available, such as via different crypto currencies, the app may allow the user to select the desired currency for the transaction from those available to send to the POS device. The POS device on receiving that information can signal, such as with a visual or audio display whether or not the selected currency is supported.

In a further embodiment, the POS device 55 and customer device 50 can engage in a handshaking process to initiate the traction where the devices switch between HICE mode and read mode to exchange data. Instead of proceeding directly to the transaction data exchange, when the POS device 55 first enters HCE mode, it can broadcast data indicating the types of currencies accepted. The customer device 55 reading this data can compare the POS supported currencies with the customer's accounts. The supported currencies that both the POS device and the customer can use can then be displayed for selection and the customer can select the one they want to use. As part of the handshaking process, the customer may be signaled after the available currencies have been read from the POS to move their device out of NFC range and then return it. The POS and customer devices can initiate the switch between HCE and read modes of operation when each detects that they are no longer within NFC read rage.

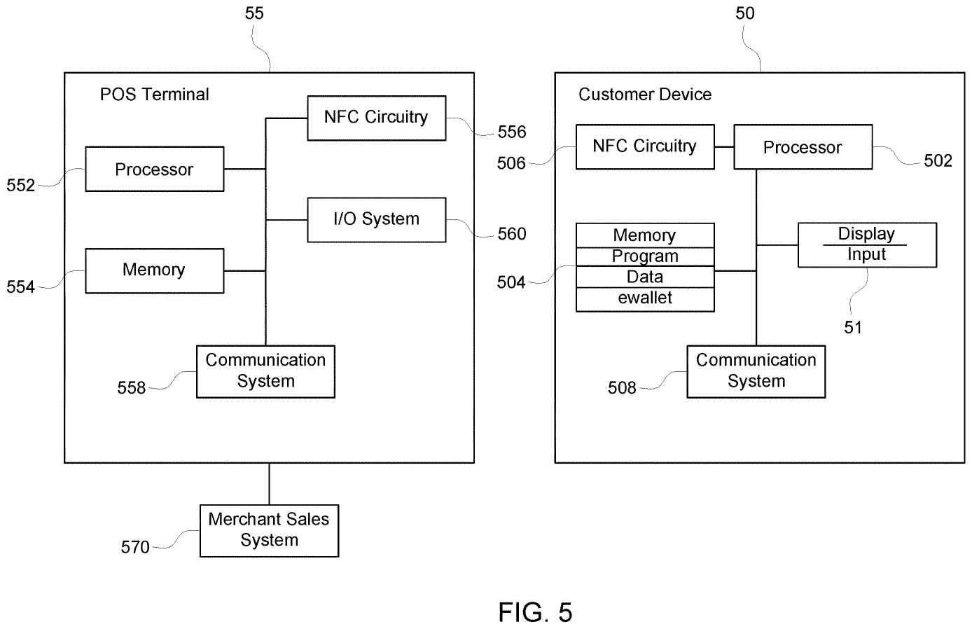

FIG. 5 is simplified block diagram of a customer device 50 and POS terminal device 55. Customer device 50 comprises one or more processors 502 connected to a memory system 504. Memory 504 is used to store the operating software for the customer device 50 and associated data, including application software to implement the customer device 50 functionality illustrated in FIGS. 4A-4C. Memory 504 can also include an e-wallet application used to store a customer's public and private key and other information related to one or more customer payment accounts that can be used in a touchless transaction. NFC circuitry 506 is controlled by processor 502 for use in the read and the HCE broadcast modes of operation. Various communication systems 508 allow the customer device 50 to communicate with external systems, including a network such as the Internet providing access to a node of the blockchain 203 associated with the customer's cryptocurrency account. Communication systems 508 can comprise cellular, WiFi, Bluetooth, and other wireless and wired communication systems.

POS device 55 comprises one or more processors 552 connected to a memory system 554. Memory 554 is used to store the operating software for the POS device 55 and associated data, including application software to implement the POS device 55 functionality illustrated in FIGS. 4A-4C. Memory 504 can also include other software, such as transaction related software and software to interact with a merchant's back-end sales system and data, including information identifying one or more merchant cryptocurrency accounts can be used in a touchless transaction. NFC circuitry 556 is controlled by processor 552 for use in the read and the HCE broadcast modes of operation. Various I/O systems 560 can be provided, including display 56, as well as other components, such as a keyboard, card slot, magnetic stripe reader, and receipt printer. Communication systems 558 allow the POS device 55 to communicate with external systems, including a network such as the Internet providing access to a node of the blockchain 203 associated with the merchant's cryptocurrency account. Communication systems 508 can comprise cellular, WiFi, Bluetooth, and other wireless and wired communication systems. POS terminal 55 can also be in communication with a merchant back-end sales system 570. While various aspects of the functionality disclosed herein, such as the POS device 55 functionality illustrated in FIGS. 4A-4C, can be performed entirely within the POS terminal 55 designed to operate in a stand-alone configuration, various functionality discussed herein as being performed by the POS terminal 55 itself can alternatively be performed by software in a merchant system 570 in communication with the POS terminal 55. For example, the merchant system 570 can receive information from a POS terminal about the initiation of a blockchain transaction as disclosed. The merchant system 570 can then monitor the blockchain to determine whether or not the transaction has been successfully recorded on the blockchain. A successful transaction can then be communicated to the POS terminal 55. Such as configuration may be more efficient (relative to stand-alone POS terminals) in a merchant facility having multiple POS terminals that can be used by customers.

For purposes of the present disclosure, the functionality disclosed as being performed by the POS device 55 should be understood as encompassing functionality performed by the POS terminal device 55 by itself or by the POS device 55 in conjunction with a back end merchant system 570

Various aspects, embodiments, and examples of the invention have been disclosed and described herein. Modifications, additions and alterations may be made by one skilled in the art without departing from the spirit and scope of the invention as defined in the appended claims.

1. A method for transaction payment by a customer to a merchant, the customer having an associated customer device and the merchant having an associated point of sale (POS) device, the POS and customer device each supporting a near field communication (NFC) protocol with a host card emulation (HCE) broadcast mode of operation and a read mode of operation, the customer and merchant having a respective account on a distributed ledger, each account having a respective public key and a private key, the method comprising the steps of:
in the customer device:
entering the NFC read mode of operation;
using the NFC read mode of operation to read from the POS device transaction information comprising a transaction amount and the merchant public key;
generating a transaction message comprising a transaction amount and the merchant public key, wherein the transaction message is signed with the customer private key;
sending the signed transaction message to the distributed ledger to initiate a transfer of currency funds represented in the distributed ledger from the customer account stored in the distributed ledger to the merchant account associated with the merchant public key.

2. The method of claim 1, further comprising the steps of, in the customer device:
outputting on a display of the customer device transaction details comprising the transaction amount;
receiving on an input of the customer device an indication of approval for the transaction; and
wherein the step of sending the transaction message occurs after receipt of the indication of approval.

3. The method of claim 2, further comprising the steps of, in the customer device:
using the merchant public key to retrieve from the distributed ledger information about the merchant account; and
wherein the transaction details output on the display of the customer device further comprise the information about the merchant account.

4. The method of claim 1, wherein the transaction information read from the POS device further comprises a transaction ID and the transaction message further comprises the transaction ID.

5. The method of claim 4, further comprising the step of, in the POS device, generating a random nonce number for use as the transaction ID.

6. The method of claim 1, further comprising the steps of, in the POS device:
entering the HCE mode of operation; and
sending the transaction amount and the merchant public key in response to an NFC read request from the customer device.

7. The method of claim 6, further comprising the steps of,
in the customer device, while in the HCE mode of operation, responding to a NFC read request from the POS device with an indication that an alternative transaction methodology is to be used and then entering the read mode of operation; and
in the POS device, while in the read mode of operation:
detecting the presence of the customer device;
initiating using the NFC protocol a read of data from the customer device; and
in response to receipt in the read request of an indication from the customer device that an alternative transaction methodology is to be used entering the HCE mode of operation.

8. The method of claim 1, further comprising the steps of, in the POS device:
monitoring the distributed ledger for an indication that the transaction has been written to the distributed ledger; and
in response to a detection that the transaction has been written outputting an indication that the transaction was successful.

9. The method of claim 1,
the POS device having an associated messaging ID and the transaction information read from the POS device further comprising the messaging ID; and
wherein the transaction message comprises a smart contract configured to, in response to a successful transfer of funds from the customer account to the merchant account, send a successful transaction message to the messaging ID.

10. A system for transaction payment by a customer to a merchant using a point of sale (POS) system supporting a near field communication (NFC) protocol, the customer and merchant each having a respective account on a distributed ledger, each account having a respective public key and a private key, the system comprising:
a customer device comprising a processor, a near field communication (NFC) system selectively operative in a read mode and a host card emulation (HCE) broadcast mode, and a memory, the memory having computer instructions stored therein that configure the customer device processor to:
set the NFC system to the read mode of operation and use the NFC read mode of operation to read from a merchant POS device transaction information comprising a transaction amount and the merchant public key;
generate a transaction message comprising a transaction amount and the merchant public key, wherein the transaction message is signed with the customer private key; and
send the signed transaction message to the distributed ledger to initiate a transfer of currency funds represented in the distributed ledger from a customer account stored in the distributed ledger to a merchant account associated with the merchant public key.

11. The system of claim 10, the computer instructions in the memory of the customer device further comprising instructions that configure the processor of the customer device to:
output on a display of the customer device transaction details comprising the transaction amount;
receive on an input of the customer device an indication of approval for the transaction; and
condition sending the transaction message on receipt of the indication of approval.

12. The system of claim 11, the computer instructions in the memory of the customer device further comprising instructions that configure the processor of the customer device to:
use the merchant public key to retrieve from the distributed ledger information about the merchant account; and
include the information about the merchant account in the transaction details output on the display of the customer device.

13. The system of claim 10, wherein the transaction information read from the POS device further comprises a transaction ID and the transaction message further comprises the transaction ID.

14. The system of claim 10, further comprising:
the POS device;
the POS device comprising a processor, a near field communication (NFC) system selectively operative in a read mode and a host card emulation (HCE) broadcast mode, and a memory, the memory of the POS device having computer instructions stored therein that configure the POS device to:
enter the HCE mode of operation; and
send the transaction amount and the merchant public key in response to an NFC read request from the customer device.

15. The system of claim 14,
the computer instructions in the memory of the customer device further comprising instructions that configure the processor of the customer device to, while in the HCE mode of operation respond to a NFC read request from the POS device with an indication that an alternative transaction methodology is to be used and then enter the read mode of operation;
the computer instructions in the memory of the POS device further comprising instructions that configure the processor of the POS device to:
enter the read mode of operation;
detect using the NFC system the presence of the customer device;
initiate using the NFC protocol a read of data from the customer device; and
in response to receipt in the read request of an indication from the customer device that an alternative transaction methodology is to be used, enter the HCE mode of operation.

16. The system of claim 14, the computer instructions in the memory of the POS device further comprising instructions that configure the processor of the POS device to:
monitor the distributed ledger for an indication that the transaction has been written to the distributed ledger; and
in response to a detection that the transaction has been written output indication that the transaction was successful.

17. The system of claim 10, wherein the transaction information read from the POS device further comprising a messaging ID for a merchant messaging account; and
wherein the transaction message comprises a smart contract configured to, in response to a successful transfer of funds from the customer account to the merchant account, send a successful transaction message to the messaging ID.

18. The system of claim 14, the computer instructions in the memory of the POS device further comprising instructions that configure the processor of the POS device to generate a random nonce number for use as the transaction ID.
